(19) United States
(12) Patent Application Publication
(10) Pub. No.: US 2026/0308940 A1
(43) Pub. Date: Oct. 8, 2026

(54) COLLAR ASSEMBLIES FOR MULTIDOSE VIALS, AND RELATED SYSTEMS AND METHODS OF USE

(71) Applicants: Rami Shorti, Salt Lake City, UT (US); Richard Cox, Salt Lake City, UT (US); Thomas Odell, Salt Lake City, UT (US); Thomas Mori, Salt Lake City, UT (US)

(72) Inventors: Rami Shorti, Salt Lake City, UT (US); Richard Cox, Salt Lake City, UT (US); Thomas Odell, Salt Lake City, UT (US); Thomas Mori, Salt Lake City, UT (US)

(21) Appl. No.: 19/461,485

(22) Filed: Jan. 27, 2026

Related U.S. Application Data
(60) Provisional application No. 63/750,687, filed on Jan. 28, 2025.

(51) Int. Cl. E05B 73/00; A61J 1/16

(52) U.S. Cl. CPC E05B 73/00; A61J 1/16

(57) ABSTRACT

Embodiments disclosed relate to systems and methods for securing multidose vials. In an embodiment, a collar assembly for multidose vials includes a first member and a second member. The first member defines a first plurality of openings and a first lock hole, the first member only partially encircling the first plurality of openings. The second member is securable to the first member and defines a second plurality of openings and a second lock hole positioned to align with the first lock hole. The second plurality of openings are positioned to at least partially align with the first plurality of openings to define a plurality of through holes extending through the collar assembly. The plurality of through holes are sized to fit around a neck of a multidose vial between a base and a head of the multidose vial to secure the multidose vial to the collar assembly.

### RELATED APPLICATIONS

This application claims priority to U.S. Provisional Application No. 63/750,687, filed on Jan. 28, 2025, and titled Collar Assemblies for Multidose Vials, and Related Systems and Methods of Use, which is incorporated herein by reference in its entirety.

### FIELD OF THE INVENTION

This application generally relates to assemblies, systems, and methods that allow multidose medicine vials to be safely and securely stored and used for optimal, efficient, cost-saving and safe delivery of medicine to patients.

### BACKGROUND

In a typical hospital setting, there is often a multidose patient specific vial (or medicinal bottle) of medication, such as insulin. Multidose patient specific vials create opportunities for waste and/or error. In a hospital setting, each vial may be kept at a nurse's station, in a patient's room, or on a medicine cart. Nurses or other providers also may retain the vial in his or her pocket. As result of the foregoing, multidose patient specific vials of medication may be wasted as result of non-use, lost due to poor handling processes and procedures, not used because of patient discharge, expire before full use, and/or not be fully used due to medication changes. For example, taking a multidose vial of insulin into multiple patient rooms is a violation of The Joint Commission. As a result, perfectly good medication, perhaps needed by another patient, becomes unavailable. Moreover, as a result of less-than-ideal storage means, both the opportunity for error, for example by extracting the incorrect multi-dose patient specific vial of medication from a pocket or bed stand, and the opportunity for non-permitted access, are heightened.

### SUMMARY

Embodiments disclosed herein include collar assemblies for multidose vials, and related systems and methods of use. In an embodiment, a collar assembly for multidose vials includes a first member defining one or more first openings and a first lock hole, a second member, and a lock. The second member defines one or more second openings and a second lock hole. The one or more second openings are positioned to at least partially align with the one or more first openings and the second lock hole is positioned to align with the first lock hole. The lock is configured to extend through the first lock hole and the second lock hole. When the lock extends through the first lock hole and the second lock hole, the first member is secured to the second member with the one or more first openings aligned with the one or more second openings to form one or more through holes extending through the collar assembly and defined at least partially by the first member and at least partially by the second member. The one or more through holes are sized to fit around a neck of a multidose vial between a base and a head of the multidose vial to secure the multidose vial to the collar assembly.

In an embodiment, a collar assembly for multidose vials includes a first member and a second member. The first member defines a first plurality of openings and a first lock hole. The first member only partially encircles the first plurality of openings. The second member is selectively securable to the first member and defines a second plurality of openings and a second lock hole positioned to align with the first lock hole. The second plurality of openings are positioned to at least partially align with the first plurality of openings to define, at least partially with the first member, a plurality of through holes extending through the collar assembly when the first member is secured to the second member. The plurality of through holes are sized to fit around a neck of a multidose vial between a base and a head of the multidose vial to secure the multidose vial to the collar assembly.

In an embodiment, a system for securing multidose vials includes a collar assembly, a tether, and a lock. The collar assembly includes a first member and a second member. The first member defines one or more first openings and a first lock hole. The second member defines one or more second openings, a second lock hole, and a tether hole. The one or more second openings are positioned to at least partially align with the one or more first openings. The second lock hole is positioned to align with the first lock hole. The tether is securable to the tether hole of the second member and an automatic dispensing machine. The lock is configured to extend through the first lock hole and the second lock hole. When the lock extends through the first lock hole and the second lock hole, the first member is secured to the second member with the one or more first openings aligned with the one or more second openings to form one or more through holes extending through the collar assembly and defined at least partially by the first member and at least partially by the second member. The one or more through holes are sized to fit around a neck of a multidose vial between a base and a head of the multidose vial to secure the multidose vial to the collar assembly.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views, or embodiments shown in the drawings.

FIGS. 1A and 1B are isometric views of a collar assembly for a multidose vial in use, according to an embodiment.

FIG. 2A is a top view of a collar assembly for a multidose vial, according to an embodiment.

FIG. 2B is a bottom view of a first member of the collar assembly of FIG. 2A, according to an embodiment.

FIG. 2C is an isometric view of the first member of the collar assembly of FIG. 2A, according to an embodiment.

FIG. 3A is a bottom view of a second member of the collar assembly of FIG. 2A, according to an embodiment.

FIG. 3B is a top view of the second member of the collar assembly of FIG. 2A, according to an embodiment.

FIG. 3C is a top isometric view of the second member of the collar assembly of FIG. 2A, according to an embodiment.

FIG. 3D is a bottom isometric view of the second member of the collar assembly of FIG. 2A, according to an embodiment.

FIG. 4A is a top isometric view of the collar assembly of FIG. 2A in a medication release position or a medication insertion position, according to an embodiment.

FIG. 4B is a top isometric view of the collar assembly of FIG. 2A in a medication capture or in-use position, according to an embodiment.

FIG. 4C is a top isometric view of the collar assembly of FIG. 2A in an initially engaged position, according to an embodiment.

FIG. 4D is a top isometric view of the collar assembly of FIG. 2A in a medication capture or in-use position with multidose vials secured thereto, according to an embodiment.

FIG. 5A is a top view of a collar assembly, according to an embodiment.

FIG. 5B is a top view of a first member of the collar assembly of FIG. 5A, according to an embodiment.

FIG. 5C is a top view of a second member of the collar assembly of FIG. 5A, according to an embodiment.

### DETAILED DESCRIPTION

Collar assemblies for multidose vials (e.g., medicinal bottles) and related systems and methods of use are disclosed herein. The collar assemblies for multidose vials, and related systems and methods of use disclosed herein increase patient safety, allow for more efficient dispensing of medicines to patients, decrease the average number of medicine vials needed per patient, secure medications, and allow for better adherence to The Joint Commission regulations and standards regarding high alert medications. More specifically, the collar assemblies disclosed herein reduce waste by using multidose vials on multiple patients safely in the medication room, thereby saving money at hospitals and medical centers. The collar assemblies disclosed herein improve compliance with regulations of The Joint Commission by ensuring that a multidose vial is not taken into multiple patient rooms. Furthermore, the collar assemblies disclosed herein improve safety by ensuring multidose vials are not mistaken. Multidose vials may be on the floor of the hospital readily available for administration using the collar assemblies disclosed herein, thereby improving timely glucose and other medication management for the patient. The collar assemblies disclosed herein also may provide a lockable assembly configured to hold a plurality of multidose medicine vials with identification barcodes, expiration dates, and access ports easily accessible while the collar assembly remains locked, thereby securing all medication attached thereto.

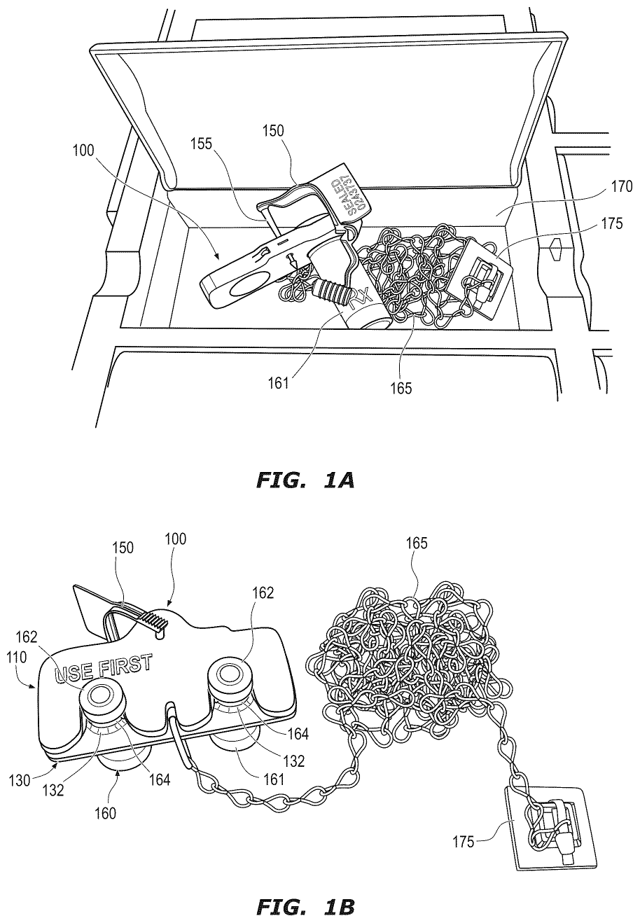

FIGS. 1A and 1B are isometric views of a collar assembly 100 for a multidose vial in use, according to an embodiment. The collar assembly 100 may be configured to tether to a drawer 170 or compartment of an automatic dispensing machine (ADM). For example, a tether 165 (e.g., a chain) may be secured to the collar assembly 100 at a first region of the tether 165 and secured to the drawer 170 at a second region of the tether 165. In some embodiments, an adhesive device 175 or another attachment mechanism with a tamper proof lock may be secured to the drawer 170 and the second region of the tether 165 to secure the tether to the drawer 170. The collar assembly 100 also is configured have a lock 150 secured thereto. The lock 150 is configured to hold the collar assembly 100 in a position that secures the multidose vials thereto. The lock 150 and/or the tether 165 may be configured to show any evidence of tampering and may include unique identifiers for registry.

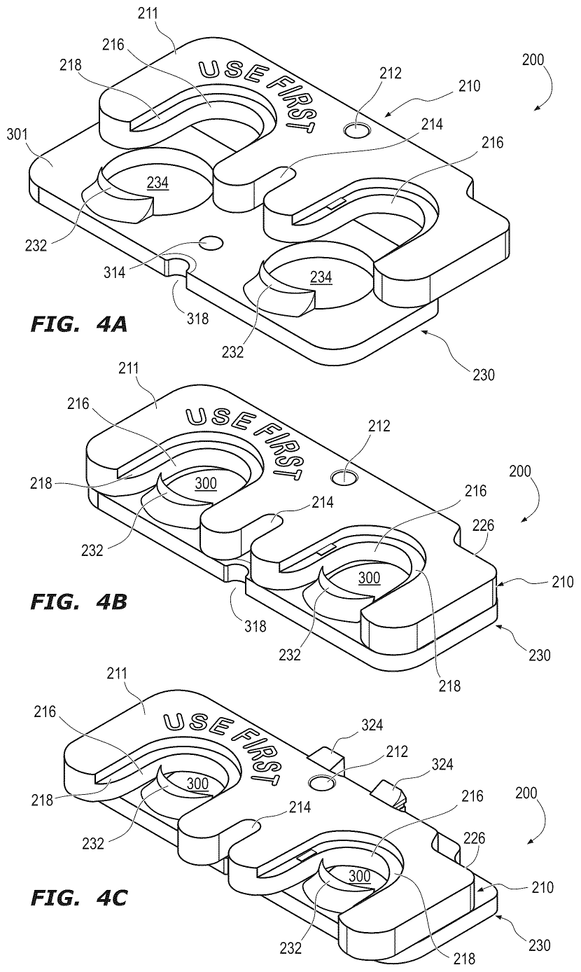

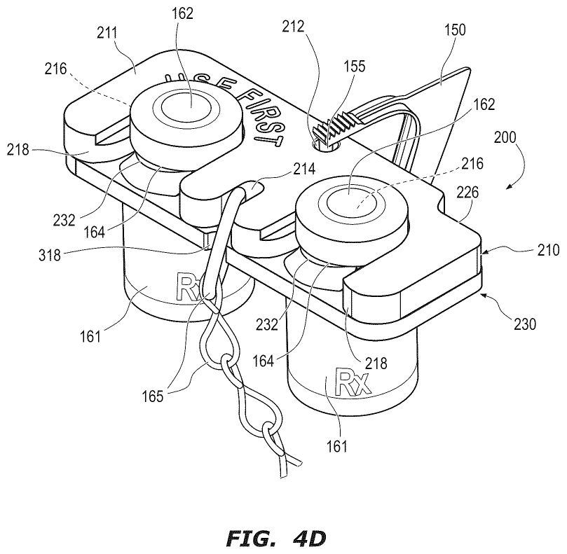

The collar assembly 100 is configured to secure one or more multidose vials 160 thereto. In the embodiment shown in FIGS. 1A and 1B, the collar assembly 100 is configured to secure two multidose vials 160. Other embodiments of the collar assembly 100 are configured to secure two, three, four, or more multidose vials 160. The collar assembly 100 also may be configured to secure one or more multidose vials 160 and also a placeholder vial 160a. The placeholder vial 160a may be sized and shaped substantially similar to or the same as the multidose vial 160. However, rather than a vial 160 having a cap and defining a chamber therein for the medicine, the placeholder vial 160a may be substantially solid or empty and configured to ensure proper balance and grip for the collar assembly 100 when all of the possible through holes 300 (shown in FIG. 4B) are not filled by multidose vials 160. For example, in FIG. 1B, the collar assembly 100 includes only a single multidose vial 160. To ensure proper balance and grip for the collar assembly 100, one placeholder vial 160a is also secured to the collar assembly 100. This configuration can aid in providing stability while drawing the content from the single multidose vial 160 into a syringe on a table top with the device attached to the cabinet.

The collar assembly 100 may include a first member 110 and a second member 130 configured to selectively secure to another and/or be positioned adjacent or at least proximate to one another to form the collar assembly 100. As shall be described in greater detail below, portions of the first member 110 and the second member 130 fit around a neck 164 of the multidose vial 160 to secure the multidose vial 160 to the collar assembly 100. The neck 164 may be narrower than the base 161 and head 162 (or cap) of the multidose vial such that the collar assembly 100 is retained around the neck 164 between the head 162 and the base 161 of the medicinal vial 160. The second member 130 may include a rib 132 or other protrusion positioned to fit around the neck 164 between the head 162 and the base 161 of the medicinal vial 160. In some embodiments, at least one of the first member 110 or the second member 130 of the collar assembly 100 may include indicators directing which multidose vial 160 should be used first.

In operation, the ADM may print a label associated with one multidose vial 165 secured to the collar assembly 100. This label is adhered to a syringe that then withdraws a selected amount of medication (e.g., insulin) from the multidose vial 165. At the bedside of the patient, the barcode on the label is scanned to confirm the medication from the correct multidose vial 165 is being administered to the correct patient.

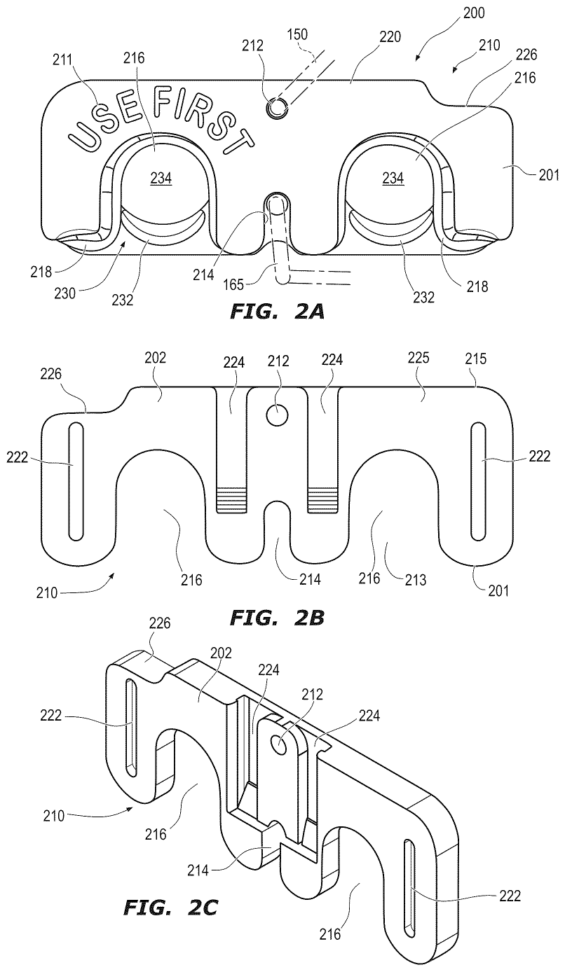

Turning ahead in the drawings, FIG. 2A is a top view of a collar assembly 200 for a multidose vial including a first member 210 and a second member 230, FIG. 2B is a bottom view of the first member 210 of the collar assembly 200, and FIG. 2C is an isometric view of the first member 210 of the collar assembly 200, according to an embodiment. Unless otherwise noted, the collar assembly 200 may include any aspect of the collar assembly 100 described above. Similarly, the collar assembly 100 may include any aspect of the collar assembly 200 described below. The collar assembly 200 may include a plastic, metal, or composite material. The collar assembly 200 may be molded or 3D printed.

The first member 210 defines one or more first openings 216, according to an embodiment. In many embodiments, the one or more first openings 216 comprise a first plurality of openings 216, such as two, three, four, or more openings. The first member 210 may only partially encircle the first plurality of openings 216. For example, the first plurality of openings 216 may extend laterally into the first member 210 from a first side 201 of the first member 210 such that the first plurality of openings 216 include an open side 213 on the first side 201 of the first member 210 and a closed side 225 on a second side 215 of the first member 210. The first member 210 may be shaped as a yoke, and the first plurality of openings 216 may be generally U-shaped.

The first member 210 may include an upper surface 220 (shown in FIG. 2A) and a lower, first interfacing surface 202 (shown in FIG. 2B) positioned to interface at least a portion of the second member 230 when the first member 210 is secured to the second member 230. In some embodiments, at the first member 210 may include indicators 211 on the upper surface 220 directing which multidose vial 160 should be used first.

The first plurality of openings 216 may be sized to fit partially around the neck 164 of a multidose vial 160 between the head 162 and the base 161 of the multidose vial 160 (shown in FIG. 4D). For example, the first plurality of openings 216 may have a width that is greater than a width of the neck 164 of the multidose vial 160, but less than a width of the head 164 and the base 161 of the multidose vial 160. This configuration prevents the multidose vial 160 from being pulled or pushed through the opening 216 of the first member 210 when secured to the second member 230. In some embodiments, the first member 210 may include a recessed rim 218 defining each of the first plurality of openings 216 and recessed from the upper surface 220. The recessed rim 218 may be sized to allow the head 162 or cap of the multidose vial to rest on the recessed rim 218.

The first member 210 defines a first lock hole 212, according to an embodiment. The first lock hole 212 may be positioned between adjacent openings of the first plurality of openings 216. The first lock hole 212 is sized to receive a portion of the lock 150 configured to secure the first member 210 to the second member 230. In some embodiments, the first member 210 also defines a slot 214 extending laterally into the first member 210 and positioned to align with the tether hole 314 of the second member 230 when the first member 210 is secured to the second member 230. The slot 314 may be sized to provide clearance for the tether 165 to extend therebetween and secure to the second member 230 at the tether hole 314. In some embodiments, the slot 314 extends inward laterally from the first side 201 of the first member 210, or the same side as the open side 213 of the first plurality of openings 216. In other embodiments, the first member 210 can include a tether hole, such as the tether hole 314 of the second member 230.

In some embodiments, the first member 210 includes one or more alignment features for aligning and/or stabilizing alignment of the first member 210 and the second member 230. For example, the first member 210 may comprise one or more grooves 224 on the first interfacing surface 202. In the embodiment shown in FIGS. 2B-2C, the first member 210 includes two grooves 224 on the first interfacing surface 202. Other embodiments may include a plurality of grooves 224 on the first interfacing surface 202, such as three or four. The grooves 224 may be positioned between adjacent openings of the first plurality of openings 216. In some embodiments, the grooves 224 extend inward from the second side 215 of the first member 210 towards the first side 201 of the first member 210. In other words, the grooves 224 extend inward from a side of the first member 210 that is opposite to the open side 213 of the first plurality of openings 216.

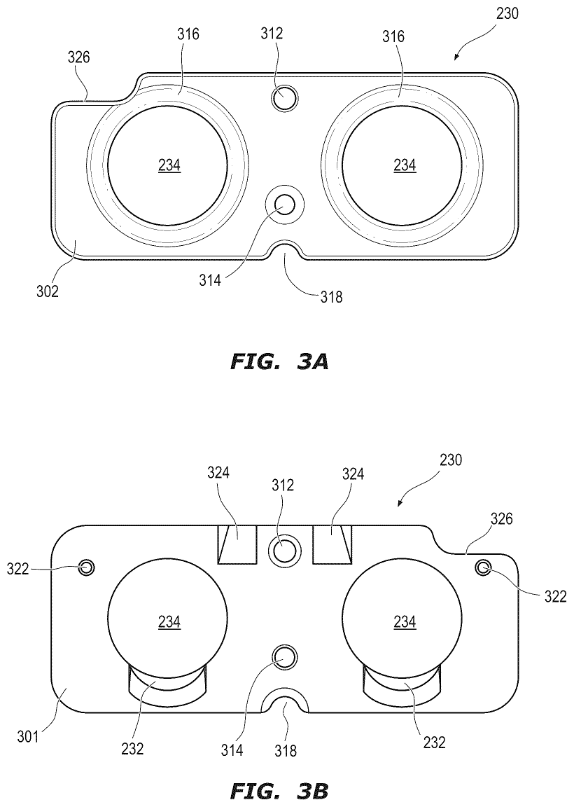

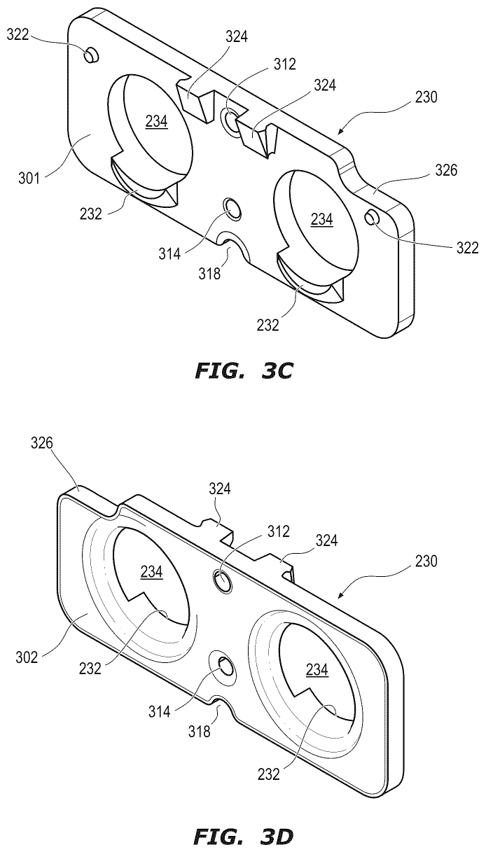

The grooves 224 may be at least partially complementary in size and/or shape to tabs 324 on the second member 230 (shown in FIG. 3B). For example, each of the grooves 224 may include a width and/or cross-sectional profile that is substantially the same or equal to a width and/or cross-sectional profile of each of the tabs 324. The grooves 224, however, may include a length that is longer than the length of the tabs 324, and the tabs 324 may slide in the grooves 224 from an inner region of the first member 210 towards the second side 215 of the first member 210. In some embodiments, the grooves 224 include a sloped segment at the inner region of the first member 210. The tabs 324 may include a complementary sloped segment, allowing the tabs 324 to more easily slide into the grooves 224. In some embodiments, the grooves 224 may be configured to engage with the tabs 324 at multiple angles. For example, the grooves 224 may be at least partially or substantially T- or L-shaped (as shown in FIG. 2C) and the tabs 324 may be shaped complementary (as shown in FIG. 3C) to the T- or L-shaped grooves 224 such that the tabs 324 may engage with the grooves 224. In some embodiments, the tabs 324 and the and the grooves 224 may be shaped or otherwise configured for the tabs 324 to form a dovetail or tongue and groove joint or engagement to secure the first member 210 to the second member 230. In some of such embodiments, the tabs 324 can slide within the grooves 224 (e.g., where the grooves 224 behave as a track), and tabs 324 engage with the grooves 224 such that the first member 210 and the second member 230 are coupled together and do not separate from one another unless the tabs 324 are removed from the grooves 224. In some embodiments, the first lock hole 212 is disposed between adjacent groves 224.

The first member 210 may further comprise one or more alignment channels 222 on the first interfacing surface 202. In the embodiment shown in FIGS. 2B-2C, the first member 210 includes two alignment channels 222 on the first interfacing surface 202. Other embodiments may include a plurality of alignment channels 222 on the first interfacing surface 202, such as three or four. The alignment channels 222 may be positioned on end regions of the first member 210, with the first plurality of openings 216 positioned between the alignment channels 222. In some embodiments, the alignment channels 222 are closed on both the first end 201 and the second end 215 of the first member 210.

The alignment channels 222 may be at least partially complementary in size and/or shape to pins 322 on the second member 230 (shown in FIG. 3B). For example, each of the alignment channels 222 may include a width and/or cross-sectional profile that is substantially the same or equal to a width and/or cross-sectional profile of each of the pins 322. The alignment channels 222, however, may include a length that is longer than the length of the pins 322, and the pins 322 may slide in the alignment channels 222.

In some embodiments, the first member 210 also may include a first security tag shelf 226. The first security tag shelf 226 may be recessed from the second side 215 of the first member 210. As shown and described in greater detail below with respect to FIG. 4D, the collar assembly 200 also may include a lock 150 having a body 154, a lock collar 152 extending from the body 154, and a bar 155 secured to the lock collar 152 and configured to extend through the first lock hole 212 and the second lock hole 312 to lock the first member 210 to the second member 230. The body 154 may be sized and dimensioned for positioning of a label or security tag thereon. When in the locked configuration shown in FIG. 4D, the lock collar 152 may be sized such that when the lock 150 is rotated or pivoted towards the collar assembly 200, the body 154 may be placed over and/or rest on the first security tag shelf 226 and a second security tag shelf 326 on the second member (shown in FIGS. 3A-3B). The shelves 226, 326, then allow the collar assembly 200 to have a smaller and more uniform profile for storage of the collar assembly 200 while the collar assembly 200 is locked with the lock 150.

Turning ahead in the drawings, FIG. 3A is a bottom view of the second member 230 of the collar assembly 200 shown in FIG. 2A, FIG. 3B is a top view of the second member 230, FIG. 3C is a top isometric view of the second member 230, and FIG. 3D is a bottom isometric view of the second member 230, according to an embodiment. The second member 230 also defines a second lock hole 312 positioned to align with the first lock hole 212 when the second member 230 is secured to the first member 210. The second member 230 defines one or more second openings 234 positioned to at least partially align with the one or more first openings 216. In many embodiments, the one or more second openings 234 comprise a second plurality of openings 234, such as two, three, four, or more openings. The second member 230 may include an equal number (e.g., two) of second openings 234 as the first openings 216 of the first member 210. The second member 230 may completely encircle each opening of the second plurality of openings 234 such that the second plurality of openings 234 comprises a second plurality of through holes extending through the second member 230. Accordingly, each opening of the second plurality of openings 234 may be substantially O- or 0-shaped.

In some alternative embodiments, the second member 230 may only partially encircle the second plurality of openings 234. For example, the second plurality of openings 234 may extend laterally into the second member 230 from a second side of the second member 230 such that the second plurality of openings 234 include an open side on the second side of the first member 230 and a closed side on a second side of the first member 230. Thus, in these embodiments, the second member 230 may be shaped as a yoke, and the second plurality of openings 234 may be generally U-shaped. In embodiments having the second member 230 only partially encircle the second plurality of openings 234, open ends of the first plurality of openings 216 are positioned opposite to open ends of the second plurality of openings 234 when the first member 210 is secured to the second member 230.

Each opening of the second plurality of openings 234 may have a width or diameter that is greater than the head 162 and the neck 164 of the multidose vial 160, but smaller than the base 161 of the multidose vial 160. Accordingly, each opening of the second plurality of openings 234 may be sized to allow the head 162 or cap of the multidose vial 160 to pass therethrough and prevent the base 161 of the multidose vial 160 from passing therethrough.

When the first member 210 is secured to the second member 230 with the first plurality of openings 216 at least partially aligned with the second plurality of openings 234, the first plurality of openings 216 and the second plurality of openings 234 together form a plurality of through holes 300 (shown in FIGS. 4B-4C) extending through the collar assembly 200. The plurality of through holes 300 are sized to fit around the neck 164 of the multidose vial 160 between the base 161 and the head 162 of the multidose vial 160 to secure the multidose vial 160 to the collar assembly 200.

The second member 230 may include a lower surface 302 (shown in FIGS. 3A and 3D) and a second interfacing surface 301 (shown in FIGS. 3B-3C). The second interfacing surface 301 may be positioned to interface with at least a portion of the first interfacing surface 202 when the first member 210 is secured to the second member 230. In many embodiments, the second member 230 comprises a plurality of ribs 232 protruding from the second interfacing surface 301 at least proximate to the second plurality of through holes 234. For example, one rib 232 may be positioned at least proximate to each opening of the second plurality of openings 234. In some embodiments, the rib 232 positioned at least proximate to the opening may at least partially define the opening of the second plurality of openings 234. Accordingly, the plurality of ribs 232 may partially define the second plurality of openings 234 and the plurality of through holes 300. The plurality of ribs 232 may be positioned on the second interfacing surface 301 to extend at least partially into the first plurality of openings 216 when the first member 210 is secured to the second member 230. More particularly, the plurality of ribs 232 may be sized and dimensioned to extend from the second interfacing surface 301 towards the head 162 of the multidose vial 160 when the multidose vial 160 is secured to the collar assembly 200 (shown in FIG. 4D). The plurality of ribs 232, then, may more securely retain the multidose vial 160 in the collar assembly 200. In some embodiments, each rib of the plurality of ribs 232 is substantially flush with the recessed rim 218 such that the bottom of the head 162 may rest on the recessed rim 218 and the rib 232.

The second member 230 also may define a tether hole 314 sized to secure the tether 165 to the second member 230. The tether hole 314 may be positioned between adjacent openings of the second plurality of openings 234 in the second member 230. The tether hole 314 may be positioned to align with the slot 214 of the first member 210 when the first member 210 is secured to the second member 230. This configuration allows the tether 165 to secure to the second member 230 while fitting in the slot 214 of the first member 210. The second member 230 also may include a slot 318 to provide clearance for the tether 165. The slot 318 may be aligned with the slot 214 of the first member 210.

The second member 230 also may include one or more alignment features corresponding to one or more alignment features of the first member 210. For example, the second member 230 may comprise the one or more tabs 324 on the second interfacing surface 301 sized and positioned to slide within the one or more grooves 224 on the first member 210 when the first member 210 is being secured or is secured to the second member 230. As previously mentioned, the one or more tabs 324 can also be shaped complementary to the one or more grooves 224 and can be configured to slidingly couple the second member 230 to the first member 210. In some embodiments, the second member 230 comprises the one or more alignment pins 322 on the second interfacing surface 301 sized and positioned to fit within the one or more alignment channels 222 on the first member 210 when the first member 210 is secured to the second member 230. The lower surface 302 of the second member 230 may include an upward sloped region 316 or curved region at least partially around the second plurality of openings 234 to allow the top of the base 161 of the multidose vial 160 to be positioned within the sloped area.

Turning ahead in the drawings, FIG. 4A is a top isometric view of the collar assembly 200 of FIG. 2A in a medication release position or a medication insertion position, FIG. 4B is a top isometric view of the collar assembly 200 of FIG. 2A in a medication capture or in-use position, FIG. 4C is a top isometric view of the collar assembly 200 of FIG. 2A in an initially engaged position, and FIG. 4D is a top isometric view of the collar assembly 200 of FIG. 2A in a medication capture or in-use position with multidose vials secured thereto, according to an embodiment. As shown in FIG. 4D, the collar assembly 200 also may include a lock 150 having a bar 155 configured to extend through the first lock hole 212 and the second lock hole 312 to lock the first member 210 to the second member 230. In some embodiments, the lock 150 is selectively releasable. When the bar 155 of the lock 150 extends through the first lock hole 212 and the second lock hole 312, the first member 210 is secured to the second member 230 with the first plurality of openings 216 aligned with the second plurality of openings 234 to form the plurality of through holes 300 extending through the collar assembly 200 and defined at least partially by the first member 210 and at least partially by the second member 230. Other types of lock mechanisms can also be used, such as a zip tie type lock mechanism.

As noted above, FIG. 4A is a top isometric view of the collar assembly 200 of FIG. 2A in a medication release position or a medication insertion position. In this position, a portion of one or more multidose vials 160 may be inserted to the collar assembly 200 through the second plurality of openings 234 in the second member 230. For example, a head 162 or cap of a multidose vial 160 may be inserted from the bottom of the second member 234 through an opening in the second plurality of openings 234 until the base 161 of the multidose vial 160 interfaces the lower surface 302 (e.g., the upward sloped region 316) of the second member 230. In this position, the second member 230 at least partially (e.g., entirely) encircles or surrounds the neck 164 of the multidose vial 160. In some embodiments, the tether 165 may be secured to the second member 230 through the tether hole 314 when the second member 230 is separated from the first member 210 (e.g., when the collar assembly is in the medication release position).

As noted above, FIG. 4B is a top isometric view of the collar assembly 200 of FIG. 2A in a medication capture or in-use position and FIG. 4D is a top isometric view of the collar assembly 200 of FIG. 2A in a medication capture or in-use position with multidose vials 160 secured thereto, according to an embodiment. Between the medication release position shown in FIG. 4A and the medication capture or in-use position shown in FIGS. 4B and 4D, the tabs 324 on the second member 230 may be inserted into the grooves 224 on the first member 210 and the pins 322 on the second member 230 may be inserted into the alignment channels 222 on the first member 210 as the first member 210 is slid onto the second member 230. The first member 210 may be slid onto the second member 230 until the closed side 225 of at least one opening of the first plurality of openings 216 is positioned at least proximate (e.g., adjacent) to the neck 164 of the multidose vial 160. In this position, at least a portion of the closed side 225 may be positioned between the head 162 and the base 161 of the multidose vial 160. Moreover, in this position, at least some of the recessed rim 218 and the rib 232 may be positioned between the head 162 and the base 161 of the multidose vial 160. Furthermore, in this position, the first lock hole 212 on the first member 210 is aligned with the second lock hole 312 on the second member 230 and a portion of the lock 155 may be inserted through the aligned first lock hole 212 and the second lock hole 312 to lock the first member 210 to the second member 230. In some embodiments, the tether 165 may be secured to the second member 230 through the tether hole 314 when the second member 230 is secured to the first member 210 (e.g., when the collar assembly is in the medication capture or in-use position).

As noted above, FIG. 4C is a top isometric view of the collar assembly 200 of FIG. 2A in an initially engaged position. As provided above, in some embodiments, the grooves 224 on the first member 210 may be configured to slidingly engage with the tabs 324 of the second member 230. To completely position the tabs 324 within the grooves 224 on the first member 210, the first member 210 may be pushed to the position shown in FIG. 4C, where the grooves 224 may include an entrance that allows the tabs 324 to slide into the grooves 224. For example, the entrance of the grooves 224 may be sloped and/or wider (shown in FIG. 2C) than the remainder of the grooves 224, thereby allowing the tabs 324 to slide into the grooves 224 and also allow the inner surfaces of the first member 210 and the second member 230 to interface one another. In this position, the tabs 324 may engage with the grooves 224 of the first member 210 while the first member 210 is slid back to a position to receive the multidose vials 160 and/or a placeholder vial 160a (similar to the positioning shown in FIG. 4A) and then remain engaged while the first member 210 is slid to a position to lock the multidose vials 160 and/or the placeholder vial 160a in the collar assembly 200 (similar to the positioning shown in FIG. 4B). In some embodiments, the tabs 324 may be snap fit into the grooves 224 rather than slid into the grooves 224.

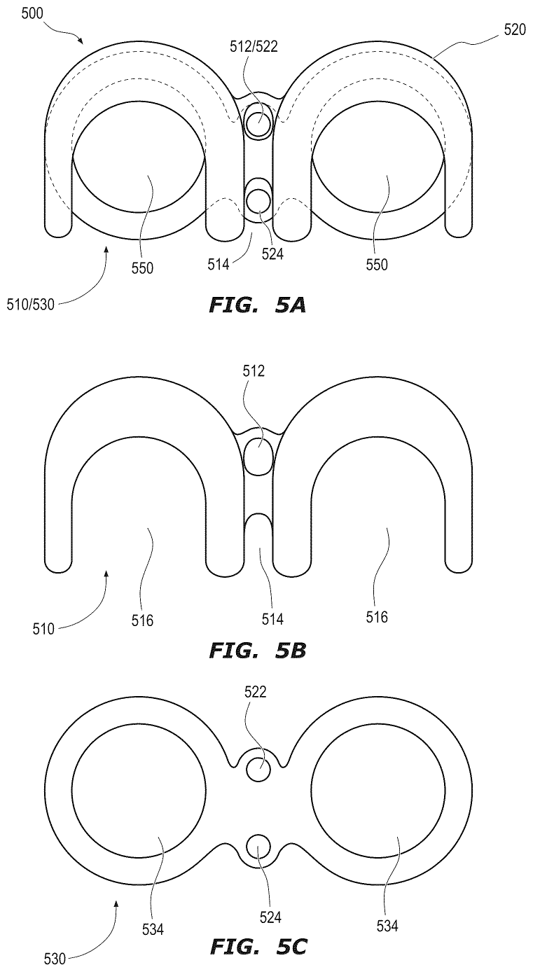

Turning ahead in the drawings, FIG. 5A is a top view of a collar assembly 500, FIG. 5B is a top view of a first member 510 of the collar assembly 500 of FIG. 5A, and FIG. 5C is a top view of a second member 230 of the collar assembly 500 of FIG. 5A, according to another embodiment. Unless otherwise noted, the collar assembly 500 may include any aspect of the collar assembly 100 or 200 described above. Similarly, the collar assembly 100 or 200 may include any aspect of the collar assembly 500 described below. The collar assembly 500 may be formed of a metal wire, according to an embodiment. Other materials (e.g., plastics, composites, etc.) may also be used.

The first member 510 defines one or more first openings 516, according to an embodiment. In many embodiments, the one or more first openings 516 comprise a first plurality of openings 516, such as two, three, four, or more openings. The first member 510 may only partially encircle the first plurality of openings 516. The first member 510 may be shaped as a yoke, and the first plurality of openings 516 may be generally U-shaped. The first plurality of openings 516 may be sized to fit partially around the neck 164 of a multidose vial 160 between the head 162 and the base 161 of the multidose vial 160. For example, the first plurality of openings 516 may have a width that is greater than a width of the neck 164 of the multidose vial 160, but less than a width of the head 164 and the base 161 of the multidose vial 160. This configuration prevents the multidose vial 160 from being pulled or pushed through the opening 516 of the first member 510 when secured to the second member 530.

The first member 510 defines a first lock hole 512, according to an embodiment. The first lock hole 512 may be positioned between adjacent openings of the first plurality of openings 516. The first lock hole 512 is sized to receive a portion of the lock 150 (not shown) configured to secure the first member 510 to the second member 530. In some embodiments, the first member 510 also defines a slot 514 extending laterally into the first member 510 and positioned to align with the tether hole 514 of the second member 530 when the first member 510 is secured to the second member 530. The slot 514 may be sized to provide clearance for the tether 165 (not shown) to extend therebetween and secure to the second member 530 at the tether hole 514. In some embodiments, the slot 514 extends inward laterally from the first side of the first member, or the same side as the open side of the first plurality of openings 516.

The second member 530 also defines a second lock hole 522 positioned to align with the first lock hole 512 when the second member 530 is secured to the first member 510. The second member 530 defines one or more second openings 534 positioned to at least partially align with the one or more first openings 516. In many embodiments, the one or more second openings 534 comprise a second plurality of openings 534, such as two, three, four, or more openings. The second member 530 may include an equal number (e.g., two) of second openings 534 as the first openings 516 of the first member 510. The second member 530 may completely encircle each opening of the second plurality of openings 534 such that the second plurality of openings 534 comprises a second plurality of through holes extending through the second member 530. Accordingly, each opening of the second plurality of openings 534 may be substantially O- or 0-shaped.

In some alternative embodiments, the second member 530 may only partially encircle the second plurality of openings 534. For example, the second plurality of openings 534 may extend laterally into the second member 530 from a side of the second member 530 such that the second plurality of openings 534 include an open side and a closed side. Thus, in these embodiments, the second member 530 may be shaped as a yoke, and the second plurality of openings 534 may be generally U-shaped. In embodiments having the second member 530 only partially encircle the second plurality of openings 534, open ends of the first plurality of openings 516 are positioned opposite to opens ends of the second plurality of openings 534 when the first member 510 is secured to the second member 530.

Each opening of the second plurality of openings 534 may have a width or diameter that is greater than the head 162 and the neck 164 of the multidose vial 160, but smaller than the base 161 of the multidose vial 160. Accordingly, each opening of the second plurality of openings 234 may be sized to allow the head 162 or cap of the multidose vial 160 to pass therethrough and prevent the base 161 of the multidose vial 160 from passing therethrough.

When the first member 510 is secured to the second member 530 with the first plurality of openings 516 at least partially aligned with the second plurality of openings 534, the first plurality of openings 516 and the second plurality of openings 534 together form a plurality of through holes 550 (shown in FIG. 5A) extending through the collar assembly 500. The plurality of through holes 550 are sized to fit around the neck 164 of the multidose vial 160 between the base 161 and the head 162 of the multidose vial 160 to secure the multidose vial 160 to the collar assembly 500. In many embodiments, the second member 530 comprises a plurality of ribs (not shown) protruding from the interfacing surface of the second member 530 at least proximate to the second plurality of openings 534.

The second member 530 also may define a tether hole 524 sized to secure the tether 165 to the second member 530. The tether hole 524 may be positioned between adjacent openings of the second plurality of openings 534 in the second member 530. The tether hole 524 may be positioned to align with the slot 514 of the first member 510 when the first member 510 is secured to the second member 530. This configuration allows the tether 165 to secure to the second member 530 while fitting in the slot 514 of the first member 510.

In FIG. 5A, the collar assembly 500 is shown in a medication capture or in-use position with the multidose vials 160 absent. In this position, at least a portion of the closed side of the first member 510 may be positioned between the head 162 and the base 161 of the multidose vial 160. Moreover, in this position, at least some of the second member 530 may be positioned between the head 162 and the base 161 of the multidose vial 160. Furthermore, in this position, the first lock hole 512 on the first member 510 is aligned with the second lock hole 522 on the second member 530 and a portion of the lock 155 may be inserted through the aligned first lock hole 512 and the second lock hole 522 to lock the first member 510 to the second member 530. In some embodiments, the tether 165 may be secured to the second member 530 through the tether hole 524 when the second member 530 is secured to the first member 210 (e.g., when the collar assembly is in the medication capture or in-use position).

As used herein, the term “about” or “substantially” refers to an allowable variance of the term modified by “about” by ±10% or ±5%. Further, the terms “less than,” “or less,” “greater than,” “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiment disclosed herein are for purposes of illustration and are not intended to be limiting.

What is claimed is:

1. A collar assembly for multidose vials, the collar assembly comprising:
a first member defining one or more first openings and a first lock hole;
a second member defining one or more second openings and a second lock hole, the one or more second openings positioned to at least partially align with the one or more first openings and the second lock hole positioned to align with the first lock hole; and
a lock configured to extend through the first lock hole and the second lock hole, wherein when the lock extends through the first lock hole and the second lock hole, the first member is secured to the second member with the one or more first openings aligned with the one or more second openings to form one or more through holes extending through the collar assembly and defined at least partially by the first member and at least partially by the second member, the one or more through holes being sized to fit around a neck of a multidose vial between a base and a head of the multidose vial to secure the multidose vial to the collar assembly.

2. The collar assembly of claim 1, wherein the one or more first openings comprise a first plurality of openings, the one or more second openings comprise a second plurality of openings, the one or more through holes comprise a plurality of through holes, the first member comprises a first interfacing surface positioned to interface at least a portion of the second member when the first member is secured to the second member, and the second member comprises a second interfacing surface positioned to interface at least a portion of the first interfacing surface when the first member is secured to the second member.

3. The collar assembly of claim 2, wherein:
the first plurality of openings extend laterally into the first member from a first side of the first member such that the first member only partially encircles the first plurality of openings, and the first plurality of openings include an open side on the first side of the first member and a closed side on a second side of the first member; and
the second plurality of openings comprises a second plurality of through holes extending through the second member.

4. The collar assembly of claim 3, wherein the second member comprises a plurality of ribs protruding from the second interfacing surface at least proximate to the second plurality of through holes, the plurality of ribs positioned on the second interfacing surface to extend at least partially into the first plurality of openings when the first member is secured to the second member.

5. The collar assembly of claim 4, wherein the plurality of ribs partially define the second plurality of through holes and are sized and dimensioned to extend from the second interfacing surface towards the head of the multidose vial when the multidose vial is secured to the collar assembly.

6. The collar assembly of claim 2, further comprising a tether hole defined by the second member.

7. The collar assembly of claim 6, wherein the tether hole is positioned between adjacent openings of the second plurality of openings in the second member.

8. The collar assembly of claim 6, wherein the first member comprises a slot extending laterally into the first member and positioned to align with the tether hole when the first member is secured to the second member.

9. The collar assembly of claim 2, wherein:
the first member comprises one or more grooves on the first interfacing surface; and
the second member comprises one or more tabs on the second interfacing surface sized and positioned to slide within the one or more grooves on the first member when the first member is secured to the second member.

10. The collar assembly of claim 2, wherein:
the first member comprises one or more alignment channels on the first interfacing surface;
the second member comprises one or more alignment pins on the second interfacing surface sized and positioned to fit within the one or more alignment channels on the first member when the first member is secured to the second member.

11. A collar assembly for multidose vials, the collar assembly comprising:
a first member defining a first plurality of openings and a first lock hole, the first member only partially encircling the first plurality of openings; and
a second member securable to the first member and defining a second plurality of openings and a second lock hole positioned to align with the first lock hole, the second plurality of openings positioned to at least partially align with the first plurality of openings to define, at least partially with the first member, a plurality of through holes extending through the collar assembly when the first member is secured to the second member, the plurality of through holes being sized to fit around a neck of a multidose vial between a base and a head of the multidose vial to secure the multidose vial to the collar assembly.

12. The collar assembly of claim 11, wherein:
the first member comprises a first interfacing surface positioned to interface at least a portion of the second member when the first member is secured to the second member; and
the second member comprises:
a second interfacing surface positioned to interface at least a portion of the first interfacing surface when the first member is secured to the second member; and
a plurality of ribs protruding from the second interfacing surface at least proximate to the second plurality of through holes, the plurality of ribs positioned on the second interfacing surface to extend at least partially into the first plurality of openings when the first member is secured to the second member.

13. The collar assembly of claim 12, wherein the plurality of ribs partially define the second plurality of through holes and are sized and dimensioned to extend from the second interfacing surface towards the head of the multidose vial when the multidose vial is secured to the collar assembly.

14. The collar assembly of claim 11, further comprising a tether hole defined by the second member.

15. The collar assembly of claim 14, wherein the tether hole is positioned between adjacent openings of the second plurality of openings in the second member.

16. The collar assembly of claim 14, wherein the first member comprises a slot extending laterally into the first member and positioned to align with the tether hole when the first member is secured to the second member.

17. The collar assembly of claim 12, wherein:
the first member comprises one or more grooves on the first interfacing surface; and
the second member comprises one or more tabs on the second interfacing surface sized and positioned to slide within the one or more grooves on the first member when the first member is secured to the second member.

18. The collar assembly of claim 12, wherein:
the first member comprises one or more alignment channels on the first interfacing surface;
the second member comprises one or more alignment pins on the second interfacing surface sized and positioned to fit within the one or more alignment channels on the first member when the first member is secured to the second member.

19. The collar assembly of claim 12, further comprising the lock configured to extend through the first lock hole and the second lock hole.

20. A system for securing multidose vials, the system comprising:
a collar assembly comprising a first member and a second member, the first member defining one or more first openings and a first lock hole and the second member defining one or more second openings, a second lock hole, and a tether hole, wherein the one or more second openings positioned to at least partially align with the one or more first openings and the second lock hole positioned to align with the first lock hole;
a tether securable to the tether hole of the second member and an automatic dispensing machine; and
a lock configured to extend through the first lock hole and the second lock hole, wherein when the lock extends through the first lock hole and the second lock hole, the first member is secured to the second member with the one or more first openings aligned with the one or more second openings to form one or more through holes extending through the collar assembly and defined at least partially by the first member and at least partially by the second member, the one or more through holes being sized to fit around a neck of a multidose vial between a base and a head of the multidose vial to secure the multidose vial to the collar assembly.
